(19) United States
(12) Patent Application Publication
(10) Pub. No.: US 2008/0302991 A1
(43) Pub. Date: Dec. 11, 2008

(54) FORCE BALANCED BUTTERFLY PROPORTIONAL HOT GAS VALVE

(75) Inventor: Raymond R. Tseng, Chandler, AZ (US)

Correspondence Address: HONEYWELL INTERNATIONAL INC., 101 COLUMBIA ROAD, P O BOX 2245, MORRISTOWN, NJ, 07962-2245, US

(73) Assignee: HONEYWELL INTERNATIONAL, INC., Morristown, NJ (US)

(21) Appl. No.: 11/779,451

(22) Filed: Jul. 18, 2007

Related U.S. Application Data
(60) Provisional application No. 60/943,196, filed on Jun. 11, 2007.

(51) Int. Cl. F16K 39/00

(52) U.S. Cl. 251/283

(57) ABSTRACT

A force balanced butterfly proportional hot gas valve is configured to receive pressurized gas from a pressurized gas source and to selectively divert the pressurized gas to one or both of two outlet nozzles. The valve includes a primary inlet, a flow passage coupled to the primary inlet, a portion of the flow passage formed into a power jet structure, a diffuser, first and second outlet nozzles coupled to the flow passage, and a butterfly element disposed at least partially within the flow passage and moveable therein to selectively divert gas flow to the first, second or both first and second outlet nozzles simultaneously.

### CROSS-REFERENCES TO RELATED APPLICATIONS

This application claims the benefit of U.S. Provisional Application No. 60/943,196, filed Jun. 11, 2007.

### TECHNICAL FIELD

The present invention relates to propulsion control systems used in aerospace, and more particularly, to a force balanced butterfly proportional hot gas valve for solid propellant control systems.

### BACKGROUND

Rockets and missiles are often guided by hot gas thruster valves that expel hot gas generated by the combusting of a solid propellant. Because of the difficulty associated with controlling and containing the hot gas, these valves are generally configured as on/off valve or pulse width modulated valves. Current and prior hot gas proportional valve designs can have problems associated with reliability or responsiveness, and can consume large amounts of electrical power.

A hot gas fluidic diverter valve, a bi-stable device, has a quick response and is a reliable valve. However, the valve is not a proportional valve. Further, the valve size may grow unacceptably large for thrust levels higher than 100 pound force (lbf). For instance, a 250 lbf thrust-level fluidic diverter valve may require a corresponding disk size of 1.3 inches and a disk housing with an outside diameter (OD) of at least 1.5 inches. Such dimensions do not take into account the fluidic size. Further, the operation of such a fluidic diverter valve may produce undesirable jitter.

Accordingly, there is a continuing need for a design of a hot gas proportional valve for solid propellant in industry which is more reliable, smaller in size, low in electrical power consumption, and fast in response as compared to current valves, which can handle at least thrust levels ranging from about 50 to greater than 1000 lbf.

### BRIEF SUMMARY

In one embodiment, and by way of example only, a force balanced butterfly proportional hot gas valve includes a primary inlet, a flow passage coupled to the primary inlet, a portion of the flow passage formed into a power jet structure, a diffuser, first and second outlet nozzles coupled to the flow passage, and a butterfly valve element disposed at least partially within the flow passage and moveable therein to selectively divert gas flow to the first, second or both first and second outlet nozzles simultaneously.

### BRIEF DESCRIPTION OF THE DRAWINGS

FIG. 1 illustrates a front cross-sectional view of an exemplary force balanced butterfly proportional hot gas valve;

FIG. 2 illustrates a side, cross sectional view of an exemplary butterfly element and a portion of an actuation shaft to drive the butterfly element;

FIG. 3 illustrates simplified schematic view of an exemplary control and actuation system for the proportional hot gas valve depicted in FIGS. 1 and 2;

FIG. 4 illustrates cross sectional view of an additional exemplary proportional hot gas valve in an additional front end, cutaway view representation;

FIG. 5 illustrates an additional exemplary embodiment of a forced balanced butterfly proportional hot gas valve; and

FIG. 6 illustrates a partial cross sectional view of an exemplary valve and motor assembly.

### DETAILED DESCRIPTION

The following detailed description is merely exemplary in nature and is not intended to limit the invention or the application and uses of the invention. Furthermore, there is no intention to be bound by any theory presented in the preceding background or the following detailed description.

A hot gas proportional valve design, which in one embodiment can be termed a “force balanced butterfly proportional hot gas valve,” can be implemented which is more reliable, consumes less electrical power, and has a faster response than presently known valves. The force balanced butterfly design is also a simpler and smaller design as opposed to other hot gas proportional valve designs, such as a so-called “pintle” valve design. The force balanced butterfly design, for example, may use only a 0.55 inch diameter butterfly, in comparison to the larger disk size requirements previously described. In addition, the total size, including the motor and the gear train, may be approximately half of the aforementioned fluidic diverter valve design. Such a size-ratio benefit can become more significant at higher thrust levels.

The proportional hot gas valve design which will be further described is a planar, two-dimensional, three-wave valve design, having an inlet and two outlets. The inlet can be a converging diverging nozzle. Between the inlet and two outlets is a butterfly at the downstream of the inlet diverging flow passage to divert the flow one way or the other. The flow to either or both sides of the outlets is directly proportional to the butterfly angular position. The angular position of the butterfly is, in one embodiment, driven by an angular torque motor with a Hall-effect position sensor for precision position. The inlet diverging section, a diffuser, is preferably designed to ensure uniform flow velocity across the opening at the upstream of the butterfly for linearity. The moment (in ft-lbf) with respect to pivot point of the butterfly is preferably designed close to zero (0) by properly designing the arm ratio to balance out the pressure differences. Therefore, minimum motor power is needed to drive the valve. A smaller motor size and effective gas dynamic design results in a faster response and smaller overall size. Finally, the design achieves good reliability. There is only one moving part in the valve (the butterfly) which is exposed to the high pressure, hot gas.

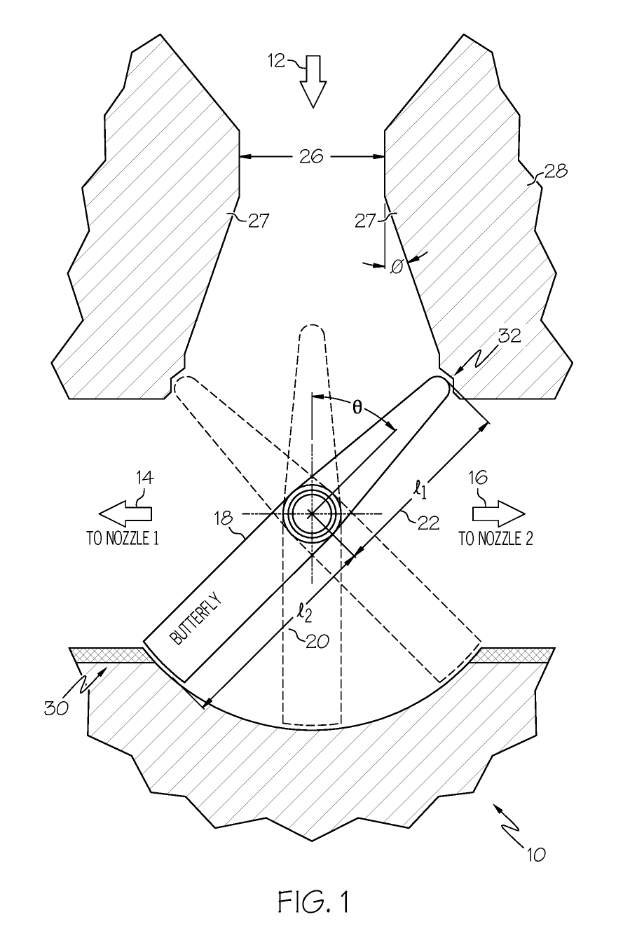

FIG. 1 depicts an exemplary proportional hot gas valve 10 incorporating a force balanced butterfly structure, as seen in a front end view. As described previously, the valve 10 may be a planar, two dimensional, three-way valve 10 with an inlet 12 and two outlets 14 and 16. A butterfly element 18 is disposed between the outlets 14 and 16, downstream of the inlet 12, to selectively divert hot gas flow supplied to the inlet 12. The butterfly element 18 may divert the flow to either side, or both of the outlets 14, 16 depending on the butterfly valve element angular position θ. Angular position θ as depicted in FIG. 1 is about 45 degrees. Length 20 and 22 give the butterfly 18 a total length (l₁+l₂), which in one embodiment is 0.30 inches (l₂)+0.25 inches (l₁), for a total length of 0.55 inches. It will be appreciated, however, that these dimensions may vary.

Valve 10 includes a power jet structure 26. In one embodiment, the power jet structure 26 is about 0.2 inches in width by 0.450 inches in height. Diffuser 27, the divergent section, makes an angle φ with vertical as shown. In one embodiment, the angle φ is less than seven (7) degrees. An adjustable wedge 30 is integrated into the housing 28 to reduce offseat leakage. Finally, the top of butterfly element 18 rests on a shoulder structure 32 to seal the outlet 16 from pressurized gas.

Valve 10, as depicted, is a 250 lbf thrust level proportional hot gas valve design. Again, butterfly valve element 18 is positioned at about 45 degrees. In this position, all of the gas flow is diverted to nozzle 1, via the outlet 14. In the depicted embodiment, this result in a net thrust of about +250 lbf. To produce a net thrust of zero, the flow should be split evenly between nozzles 1 (via outlet 14) and 2 (via outlet 16) and the butterfly should be angled at 0 degrees. For a −250 lbf thrust, all the flow should be diverted to nozzle 2 (again via outlet 16), and the butterfly should be angled at −45 degrees. These latter two positions are shown in phantom in FIG. 1. Hot gas enters inlet 12 at about 2000 pounds per square inch absolute (psia). Off side leakage (in this case, leakage to nozzle 2 via outlet 16) can be designed to be less than three (3) percent. The butterfly 18 arm ratio (l₁/l₂) can be designed to balance out pressure differences.

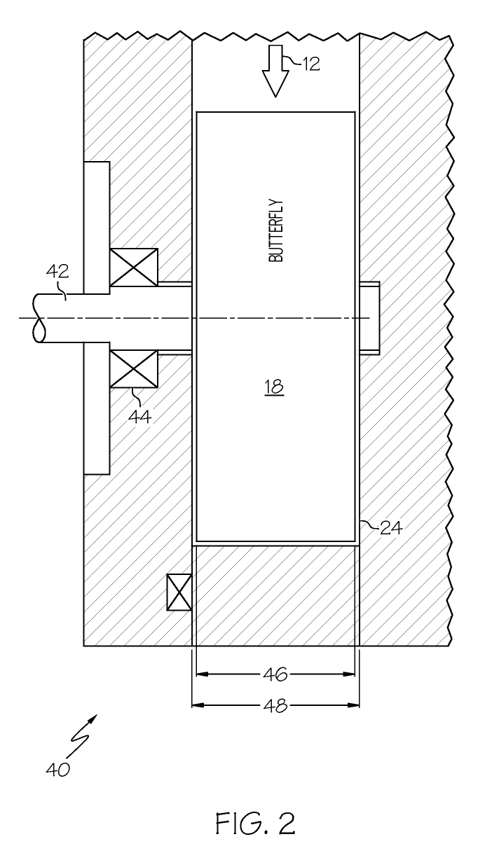

Turning to FIG. 2, a side, cross sectional view 40 of butterfly element 18, coupled to a portion of an actuation shaft 42, is seen. Actuation shaft 42 is further coupled, in at least one particular embodiment, to a drive train gear, an angular torque motor, a Hall-effect position sensor device as will be further described. A DC motor, or a step motor, can also be utilized to replace the angular torque motor. A graphfoil seal 44 seals the actuator shaft 42 from the hot, pressurized gas. In one embodiment, the width 46 preferably can vary between about 0.442 inches to about 0.444 inches. Similarly, the width 48 of a respective cavity in which the butterfly element 18 actuates can vary between about 0.449 inches to about 0.451 inches. As a result, the leakage to nozzle 2 (again via outlet 16) can be calculated as: (0.451-0.442)/0.443=0.020 (2.0%).

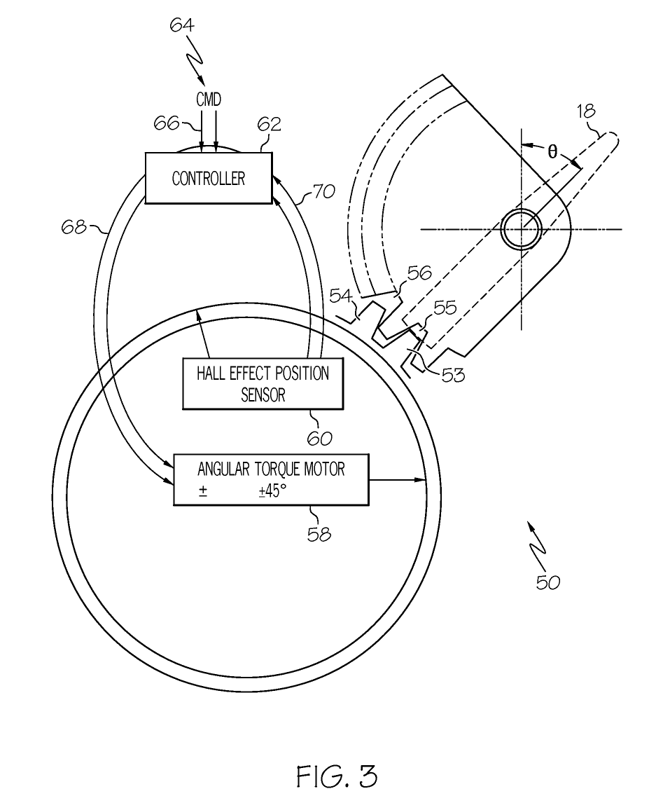

FIG. 3 illustrates an exemplary simplified schematic view of an actuation system 50 that may be used to move and control the valve 10. The actuation system 50 includes a controller 62 responsive to a command 64, an angular torque motor 58, a Hall-effect position sensor 60 and two gears (i.e., gears 53-56). A respective gear ratio can be designed for a required torque. For an accurate angular position control, the angular position of the butterfly is detected by the Hall-effect position sensor 60 and fed back to the controller 62 (via signals 70) to compare with the command signal. The controller will then send signals 68 to the angular torque motor 58 to correct the angular position.

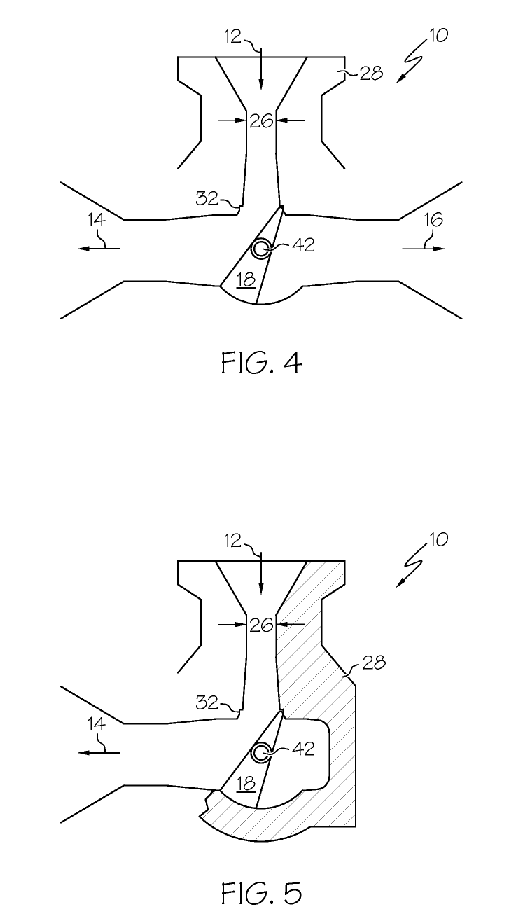

FIG. 4 illustrates an additional exemplary cross sectional view of a valve 10, including the inlet 12, the outlets 14 and 16, the butterfly element 18 coupled to the actuation shaft 42, the power jet structure 26, the diffuser 27, and the shoulders 32 integrated into the wall of the housing 28 to provide for sealing.

FIG. 5 illustrates an additional embodiment of a valve 10 having a single outlet 14 leading to a nozzle. Outlet 16 is replaced with a portion of housing 28 as shown. The valve 10 depicted in FIG. 5 demonstrates that an implementation similar to those shown with two outlets 14 and 16, but only having a single outlet 14, can be constructed for a particular application.

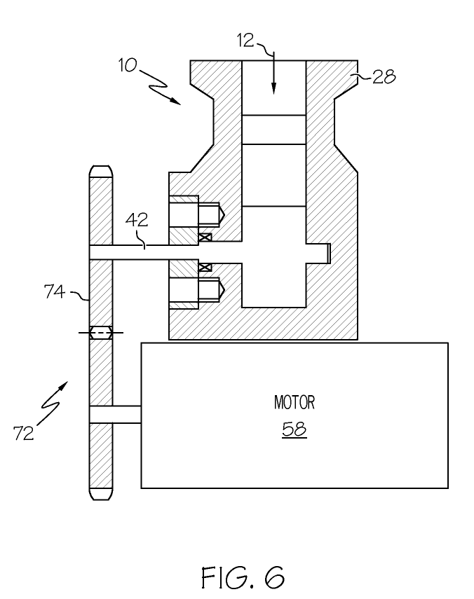

FIG. 6 illustrates a partial cross sectional view of an exemplary valve and motor assembly 72. Valve 10 is coupled to motor 58 via a drive mechanism 74. Motor 58 can include a two-pole angular torque motor with a Hall-effect position sensor. In one embodiment, the motor 58 may be energized from a DC supply of between 24 to 32 volts, with a corresponding motor resistance of about 9 ohms, and peak power of 81 watts at 28 volts.

Device 10 is a true proportional valve having smooth operation. Precision angular position is maintained through the use of Hall-effect sensor feedback control. In one embodiment, the expected linear range varies from about 5% to about 95%. The device 10 exhibits little or no jitter.

Device 10 is small in size. A small motor size is realized with a force balanced butterfly design. The size of the butterfly for a 250 Lbf thrust valve 10 as shown is only about 0.701 inches by 0.45 inches. Compared to a 1.3 inch diameter disk in a 250 lbf fluidic disk diverter valve, the overall size of a butterfly valve is approximately one-third of the size of a fluidic diverter valve.

Device 10 is responsive. A fast response is achieved with small motor size and the fact that the butterfly 18 need rotate only 50 to 90 degrees from fully closed to a fully open position or vise versa. In one embodiment, the response time is expected to be less than six (6) milliseconds (ms) for a 250 lbf thrust level valve, and less than three (3) ms for a 20 lbf thrust valve. The other hot gas proportional valve designs such as a so-called “pintle” valve design need to make several revolutions to fully close or open the valve therefore is much slower than this invention.

Finally, device 10 is low in cost. A simple design involves only one moving part exposed to hot gas. Device 10 includes few component counts in its respective design. The design involves no challenging manufacturing accuracies and processes. A smaller size design may use much less rhenium than a comparable fluidic diverter valve design. The angular torque motor with Hall-effect sensor costs only a fraction of an implementation using a DC motor with a commutator. The controller/driver for the angular torque motor is also much simpler and cheaper than the DC motor control system. The other hot gas proportional valve designs such as a so-called “pintle” valve design have to employ a DC motor and a more expensive controller/driver for complicated commutation.

While the invention has been described with reference to a preferred embodiment, it will be understood by those skilled in the art that various changes may be made and equivalents may be substituted for elements thereof without departing from the scope of the invention. In addition, many modifications may be made to adapt to a particular situation or material to the teachings of the invention without departing from the essential scope thereof. Therefore, it is intended that the invention not be limited to the particular embodiment disclosed as the best mode contemplated for carrying out this invention.

What is claimed is:

1. A force balanced butterfly proportional hot gas valve, comprising:
a primary inlet;
a flow passage coupled to the primary inlet, a portion of the flow passage formed into a power jet and diffuser structure;
at least one outlet coupled to the flow passage; and
a butterfly element disposed at least partially within the flow passage and moveable therein to selectively divert gas flow to the at least one outlet, an additional outlet, or both the at least one outlet and additional outlet simultaneously.

2. The valve of claim 1, wherein the butterfly element is a planar, two-dimensional, three-way valve which is force balanced for operating efficiency.

3. The valve of claim 1, further including a housing incorporating at least a portion of the flow passage.

4. The valve of claim 3, further including an adjustable wedge integrated into the housing to reduce offseat leakage of gas.

5. The valve of claim 1, further including an actuation shaft coupled between the butterfly valve element and a drive mechanism.

6. The valve of claim 5, wherein the drive mechanism further comprises a drive train gear, a sensor device, an angular torque motor or a direct current (DC) motor, or a step motor.

7. The valve of claim 1, further including an actuation system to drive the butterfly element comprising:
a controller responsive to a command;
an angular torque motor in electrical communication with the controller;
a Hall-effect sensor in electrical communication with the controller; and
a gear in mechanical communication with the angular torque motor.

8. The valve of claim 1, wherein the controller is responsive to a feedback signal from the Hall-effect sensor.

9. The valve of claim 3, further comprising:
a shoulder integrated into a wall of the housing to receive a portion of the butterfly element and seal the at least one outlet.

10. The valve of claim 6, wherein the sensor device further comprises a Hall-effect sensor position device.

11. The valve of claim 5, further comprising:
a control unit operable to selectively supply the one or more control signals to the drive mechanism.

12. The valve of claim 1, wherein the butterfly element selectively diverts the gas flow to the at least one outlet, the additional outlet, or both the at least one outlet and the additional outlet depending on an angular position.

13. The valve of claim 5, further including a graphfoil seal radially disposed around a portion of the actuator shaft to seal the actuator shaft from gas leakage.

14. The valve of claim 7, wherein the gear is designed according to a ratio to effect a torque on the butterfly element.

15. A force balanced butterfly proportional hot gas valve, comprising:
a primary inlet;
a flow passage coupled to the primary inlet, a portion of the flow passage formed into a power jet structure and a diffuser;
first and second outlet nozzles coupled to the flow passage;
a butterfly element disposed at least partially within the flow passage and moveable therein to selectively divert gas flow to the first, second or both first and second outlet nozzles simultaneously; and
an actuation system coupled to the butterfly element, including a controller responsive to a command, an actuator in electrical communication with the controller, a Hall-effect sensor in electrical communication with the controller; and a gear in mechanical communication with the angular torque motor.

16. The valve of claim 15, further including a housing incorporating at least a portion of the flow passage.

17. The valve of claim 16, further including an adjustable wedge integrated into the housing to reduce offseat leakage of gas.

18. The valve of claim 15, wherein the actuator further includes an angular torque motor, or a direct current (DC) motor, or a step motor.

19. The valve of claim 15, wherein the controller is responsive to a feedback signal from the Hall-effect sensor.

20. The valve of claim 15, further including a graphfoil seal radially disposed around a portion of the actuator shaft to seal the actuator shaft from gas leakage.
